(19) United States
(12) Patent Application Publication
(10) Pub. No.: US 2009/0077470 A1
(43) Pub. Date: Mar. 19, 2009

(54) Online Anonymous Multi-Session Trials

(76) Inventors: Manu Mehta, Fremont, CA (US); Lynn Randolph Slater, JR., Fremont, CA (US)

Correspondence Address: Ashok Tankha, 36 Greenleigh Drive, Sewell, NJ, 08080, US

(21) Appl. No.: 12/212,647

(22) Filed: Sep. 17, 2008

Related U.S. Application Data
(60) Provisional application No. 60/994,040, filed on Sep. 17, 2007.

(51) Int. Cl. G06F 3/048

(52) U.S. Cl. 715/738

(57) ABSTRACT

Disclosed herein is a computer implemented method and system for enabling a user to anonymously participate in trials over multiple sessions. A temporary user identifier is generated for the user. The temporary user identifier is stored locally on a client device of the user. Anonymous access to multiple online tools on a host website is granted to the user for a predetermined period of time using the temporary user identifier. The user may participate anonymously in the trials over the multiple sessions using the online tools for the predetermined period of time. The participation in the trials comprises performing online activities on the host website by the user. The user may register with the host website by providing user identification information to obtain unlimited access to the online tools.

### CROSS REFERENCE TO RELATED APPLICATIONS

This application claims the benefit of U.S. provisional patent application No. 60/994,040 titled “Online Anonymous Multi-Session Trials”, filed on Sep. 17, 2007 in the United States Patent and Trademark Office.

### BACKGROUND

This invention, in general, relates to web technology. More particularly, this invention relates to anonymous participation of a user in online multi-session trials.

Web visitors typically dislike providing identification information, for example, names or electronic mail addresses until the web visitors are convinced of the value provided by a website. Web visitors typically assess the offerings of the website and determine the value of the website prior to providing identification information. Web visitors may also be less inclined to register on the website before accessing the services offered by that website. Registration may therefore prove to be an obstacle for web visitors and the web visitors may choose to discontinue interacting with that website.

Hence, there is an unmet need for a computer implemented method and system for enabling the user to participate in online multi-session trials while maintaining the anonymity of the user for a predetermined period of time.

### SUMMARY OF THE INVENTION

This summary is provided to introduce a selection of concepts in a simplified form that are further described in the detailed description of the invention. This summary is not intended to identify key or essential inventive concepts of the claimed subject matter, nor is it intended for determining the scope of the claimed subject matter.

The computer implemented method and system disclosed herein addresses the above stated need for enabling the user to participate in online multi-session trials while maintaining the anonymity of the user for a predetermined period of time.

A web server generates a temporary user identifier for a user. The temporary user identifier is stored locally on a client device of the user. The user is granted anonymous access to multiple tools on a host website for a predetermined period of time, for example, a week. The host website provides the user the online tools for performing the online activities. The host website is hosted on a web server. The web server grants the user anonymous access using the temporary user identifier. The host website hosted on the web server therefore enables the user to anonymously participate in the trials over multiple sessions using the online tools for the predetermined period of time. The multiple sessions may be multiple browser sessions. The participation in the trials comprises performing online activities by the user on the host website within the predetermined period of time. The web server manages the content of the trials. The web server further notifies the user of expiration of the predetermined period of time.

The temporary user identifier for the user may be displayed to the user and stored as a web cookie on the client device of the user. As used herein, the term “web cookie” is defined as a parcel of data stored on the client device and sent back unchanged by the client device to the web server each time the client device accesses the web server. The user is not required to provide any identification information by filling in registration forms or signing up at the host website prior to performing the online activities. The online activities may comprise providing information and interacting with the host website by the user to create web elements on the host website. The online activities may further comprise creation of a user website, financial planning, home value assessments, health assessments, travel planning, etc. The user performs the online activities using the online tools on the host website within the predetermined period of time. If the user participates in the online trials over multiple sessions, the temporary user identifier stored as the web cookie enables the host website to associate the information stored from a previous browser session with the user for a new browser session.

The user may register with the host website to obtain unlimited access to the online tools. The user may register with the host website by providing user identification information, for example, name, electronic mail (email) address, etc. After registering, the user may use the online tools without time limits or functionality limits.

### BRIEF DESCRIPTION OF THE DRAWINGS

The foregoing summary, as well as the following detailed description of the invention, is better understood when read in conjunction with the appended drawings. For the purpose of illustrating the invention, exemplary constructions of the invention are shown in the drawings. However, the invention is not limited to the specific methods and instrumentalities disclosed herein.

FIG. 1 illustrates a computer implemented method of enabling a user to anonymously participate in trials over multiple sessions.

FIG. 2 illustrates a computer implemented system for enabling a user to anonymously participate in trials over multiple sessions.

FIG. 3 exemplarily illustrates steps involved in an online activity of creating a user website using the host website by an anonymous user.

FIG. 4 exemplarily illustrates a screenshot of an interface enabling the user to select a template for creation of a user website.

FIG. 5 exemplarily illustrates a screenshot of a confirmation screen for confirming use of a selected template.

FIG. 6 exemplarily illustrates a screenshot of a site management screen.

FIG. 7 exemplarily illustrates a screenshot of a user website created using the selected template.

FIG. 8 exemplarily illustrates a screenshot of a web page for enabling the user to add blocks to the user website.

FIG. 9 exemplarily illustrates a screenshot of a web page of the user website with an added calendar block.

FIG. 10 exemplarily illustrates a screenshot of an interface enabling the user to add additional blocks to the user website.

FIGS. 11A-11B exemplarily illustrate screenshots of web pages of the created user website with a notification of expiration of the predetermined period of time.

FIG. 12 exemplarily illustrates a screenshot of a web page for allowing the user to select a new template for the user website.

FIG. 13 exemplarily illustrates a screenshot of a web page for warning the user about loss of changes made prior to selection of the new template.

FIG. 14 exemplarily illustrates a screenshot of a web page for allowing the user to register with the host website.

FIG. 15 exemplarily illustrates a screenshot of a web page for allowing the user to provide user identification information to the host website.

FIGS. 16A-16B exemplarily illustrate information on two web cookies of the temporary user identifier stored on the client device.

### DETAILED DESCRIPTION OF THE INVENTION

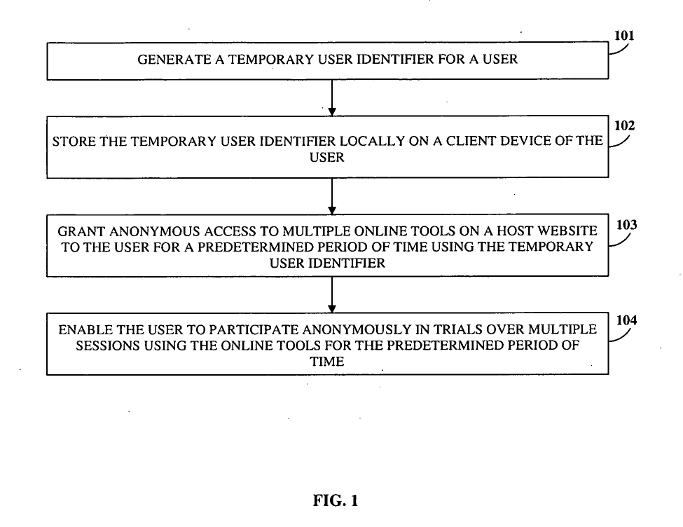

FIG. 1 illustrates a computer implemented method of enabling a user to anonymously participate in trials over multiple sessions. A web server generates 101a temporary user identifier for a user. The web server generates the temporary user identifier automatically when the user visits a host website hosted on the web server. The generation of the temporary user identifier does not require the user to fill forms, provide user identification details, for example, name, electronic mail (email) address, etc., or register with the host website. A user unregistered with the host website may visit the host website and the temporary user identifier is automatically generated with minimal input from the user.

The temporary identifier is stored 102 locally on a client device of the user. The temporary user identifier for the user may be displayed to the user and stored as a web cookie. As exemplarily used herein, the term “web cookie” is defined as a parcel of data stored on a client device and sent back unchanged by the client device to the web server each time the client device accesses the host website hosted on the web server. The host website provides multiple online tools to the user. The user is granted 103 anonymous access to the multiple online tools on the host website for a predetermined period of time using the temporary user identifier. The predetermined period of time may be, for example, a week.

The user may be granted anonymous access to the host website over multiple sessions within the predetermined period of time. The multiple sessions may be multiple browser sessions. The temporary user identifier stored as the web cookie enables the host website to associate the information stored from a previous browser session with the user for a new browser session. Hence, the user may end a browser session and disconnect access to the host website without losing the temporary user identifier. When the user starts a new browser session and visits the host website, the host website reads the stored temporary user identifier and identifies the user.

The host website hosted on the web server enables 104 the user to participate anonymously in the trials over the multiple sessions using the online tools for the predetermined period of time. The participation in the trials may comprise performing online activities by the user on the host website within the predetermined period of time. The user may participate in the trials over multiple sessions by anonymously accessing the online tools on the host website and using services offered by the host website on an evaluation basis. The trials may aid the user in making a decision about further use of the services offered by the host website. For example, if the user likes the services offered by the host website during the session trials, the user may decide to obtain advanced services from the host website by registering with the host website for the advanced services. The web server also manages the content of the trials.

The online activities may comprise providing information and interacting with the host website by the user to create web elements on the host website. The online activities may further comprise creating a user website, financial planning, home value assessments, health assessments, travel planning, etc. The user may also add a calendar block or edit the content of preexisting blocks, change text in a header block, change an image on the home page, or change the text in a block comprising introductory paragraphs for the user website. The user is not required to provide any identification information by filling in registration forms or register with the host website prior to performing the online activities. The user performs the online activities using the online tools on the host website within the predetermined period of time. The user may be notified of expiration of the predetermined period of time. The notification may comprise a message displaying number of days remaining till the expiration of the predetermined period of time.

The user may register with the host website to obtain unlimited access to the online tools. The user may register with the host website by providing user identification information, for example, name, electronic mail (email) address, etc. After registering, the user may use the online tools without time limits or functionality limits. The unlimited access may be an incentive for the user to provide user identification information, for example, user name or electronic mail (email) address of the user.

Consider an example of an online activity of creation of a user website. The user selects one of multiple templates, associated content of the templates, and online tools from the host website hosted on the web server. The user then creates the user website using at least one of the online tools without revealing any identification or authentication information. The user is also not required to fill in any registration forms or sign up with the host website to create the user website. The host website therefore permits the user to create the user website on a trial basis over multiple sessions for a predetermined period of time. The predetermined period of time may be measured in days or weeks. For the predetermined period of time, the host website generates a temporary user identifier for the user. The temporary user identifier is stored as a web cookie on the client device of the user. The host website displays the temporary user identifier to the user. The identity of the user is determined by the host website using only the generated temporary user identifier displayed to the user. The user may end a session of a trial by closing a browser session. The user may resume the online session trial in a second browser session before expiration of the predetermined period of time as long as the temporary user identifier is known to the user or stored in the web cookie on the client device.

Consider another example of an online session activity of creation of a value estimate for personal real estate. The user selects at least one of multiple templates, associated content of the templates, and online tools from the host website. One of the selected templates may be a template for stand-alone homes and one other may be a template for condos. The user then creates a value model by entering information and choosing different configurations without revealing any identification or authentication information. The user is not required to fill in any registration forms. The host website therefore permits the user to create value assessments on a trial basis over multiple sessions for a predetermined period of time. The host website generates a temporary user identifier for the user for the predetermined period of time. The host website displays the temporary user identifier only to the user. The identity of the user is determined by the host website using only the generated temporary user identifier displayed to the user and stored as a web cookie on the client device of the user.

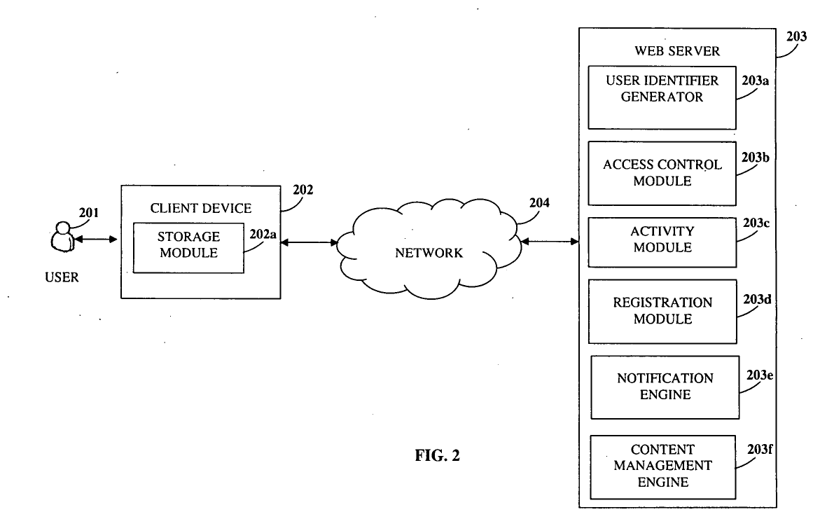

FIG. 2 illustrates a computer implemented system for enabling a user 201 to anonymously participate in trials over multiple sessions. The system disclosed herein comprises a web server 203 and a client device 202 connected via a network 204.

The web server 203 hosts a host website. The web server 203 comprises a user identifier generator 203a, an access control module 203b, an activity module 203c, a registration module 203d, a notification engine 203e, and a content management engine 203f. The user identifier generator 203a generates a temporary user identifier for the user 201. The user identifier generator 203a generates the temporary user identifier without requiring the user 201 to fill forms, provide user identification details or register with the host website. The user identifier generator 203a generates the temporary user identifier with minimal inputs from the user 201.

The client device 202 may be, for example, a personal computer, a laptop, a mobile phone, a personal digital assistant, etc. The client device 202 comprises a storage module 202a. The storage module 202a stores the generated temporary user identifier as a web cookie. The client device 202 provides the user 201 access to the host website implemented on the web server 203 via the network 204. The client device 202 sends the temporary user identifier unchanged to the web server 203 each time the client device 202 accesses the host website hosted on the web server 203. The web server 203 provides multiple online tools for enabling the user 201 to perform online activities. The access control module 203b grants the user 201 anonymous access to multiple online tools on the host website for a predetermined period of time using the temporary user identifier. The predetermined period of time may be determined by the web server 203.

The activity module 203c enables the user 201 to participate anonymously in the trials over the multiple sessions using the online tools for the predetermined period of time. The participation in the trials may comprise performing online activities by the user 201 within the predetermined period of time. The online activities comprise providing information and interacting with the host website to create web elements on the host website. The online activities may further comprise, for example, creation of a user website, financial planning, home value assessments, health assessments, travel planning, etc. The content management engine 203f manages content of the trials. The notification engine 203e notifies the user 201 of expiration of the predetermined period of time. The notification may comprise a message displaying number of days remaining till the expiration of the predetermined period of time.

The user 201 may register with the host website by providing user identification information, for example, name, email address, etc. to obtain unlimited access to the online tools. The registration module 203d registers the user 201 with the host website. The user 201 registers with the host website by providing user identification information to obtain unlimited access to the online tools. After registering, the user 201 may use the online tools without time limits or functionality limits. The unlimited access may be an incentive for the user 201 to provide user identification information, for example, name or email address of the user 201.

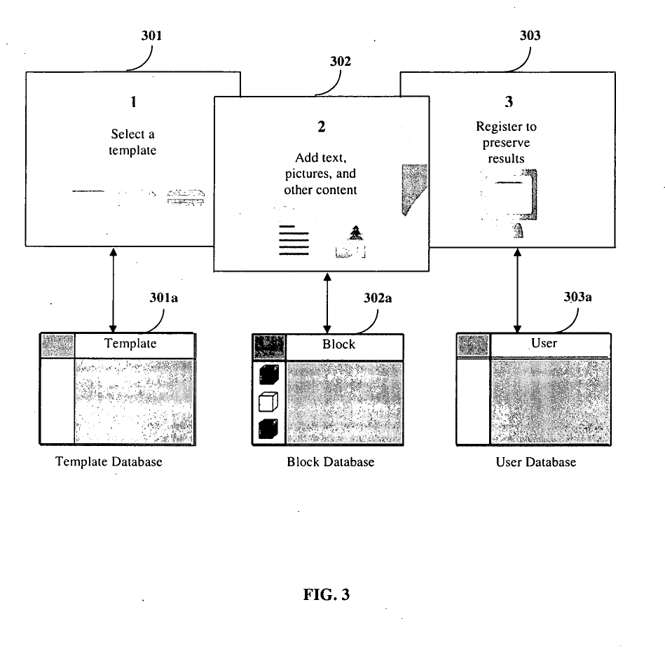

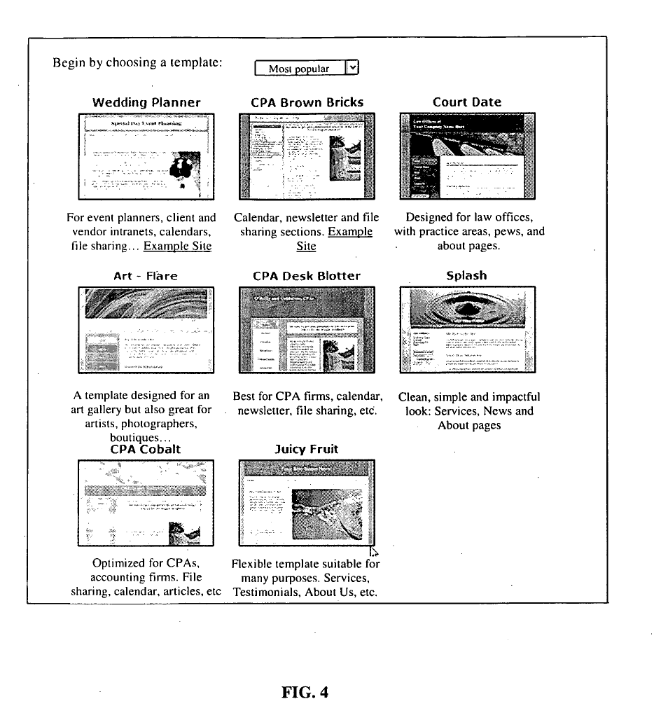

FIG. 3 exemplarily illustrates steps involved in an online activity of creating a user website using the host website by an anonymous user. The user 201 initiates the creation of the user website using the host website hosted on the web server 203 without revealing any identification information. The web server 203 generates a temporary user identifier valid for a predetermined period of time. The temporary user identifier is stored on the client device 202. The user 201 may create the user website by selecting 301a template stored in a template database 301a of the web server 203. A screenshot of an interface enabling the user 201 to select a template for creation of the user website is exemplarily illustrated in FIG. 4. The template database 301a provides website templates. The template database 301a comprises a variety of templates suited for different applications. The templates stored in the template database 301a comprise page layouts, tools, and content used for creating the user website. The user 201 selects at least one of a block or a template to create the user website. The user 201 customizes the user website by editing text, images and other website features.

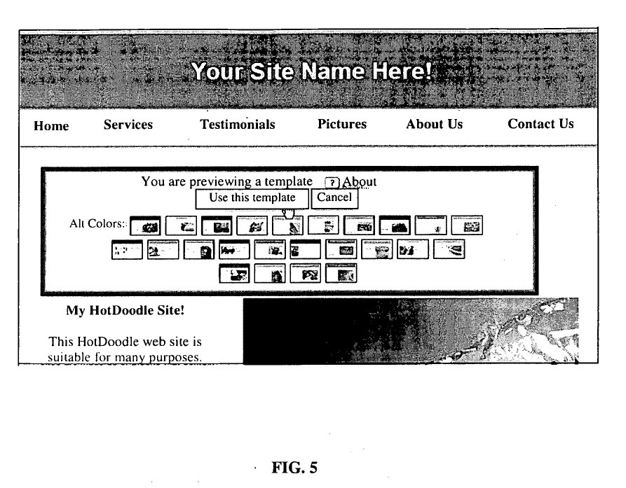

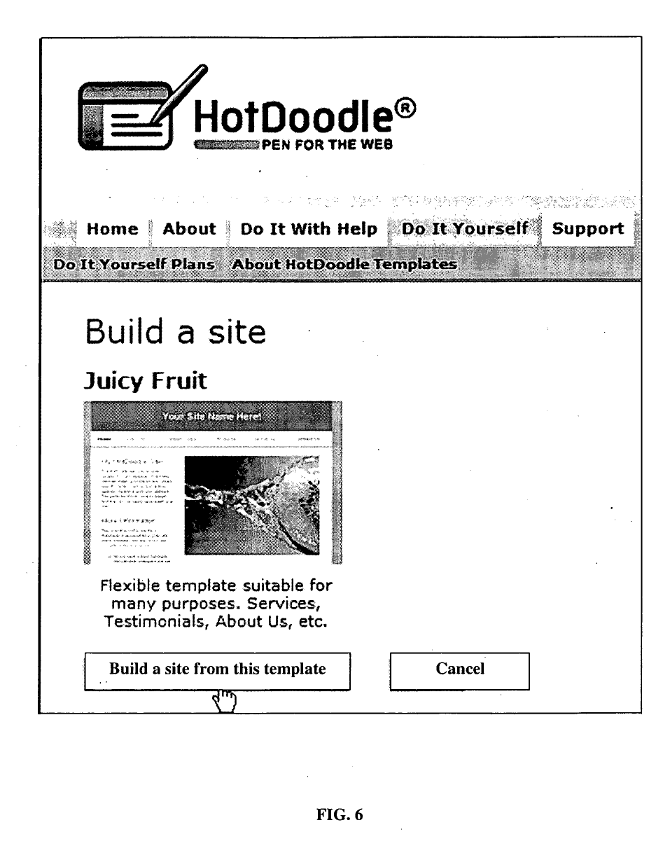

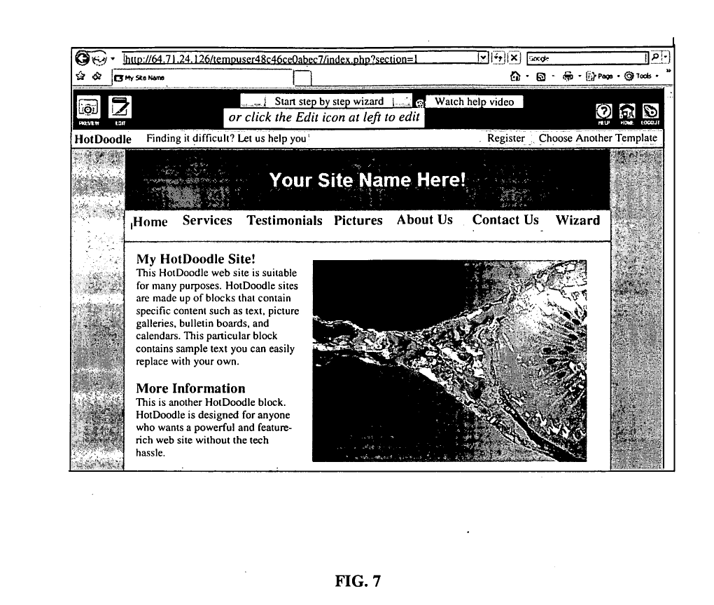

After the user 201 selects the template, the web server 203 presents the user 201 with a confirmation screen for confirming use of the selected template for creation of the user website. A screenshot of the confirmation screen for confirming use of the selected template is exemplarily illustrated in FIG. 5. On confirming the use of the selected template, the user 201 is directed to a site management screen via a link in the confirmation screen. A screenshot of the site management screen is exemplarily illustrated in FIG. 6. The user 201 then creates the user website based on the selected template. A screenshot of a user website created using the selected template is exemplarily illustrated in FIG. 7. The created user website is temporary in nature. In FIG. 7, the web address for the user website is, exemplarily, “http://64.71.24.126/tempuser48c46ce0abec7/index.php?section=1”. The web address reflects the temporary nature of the user website.

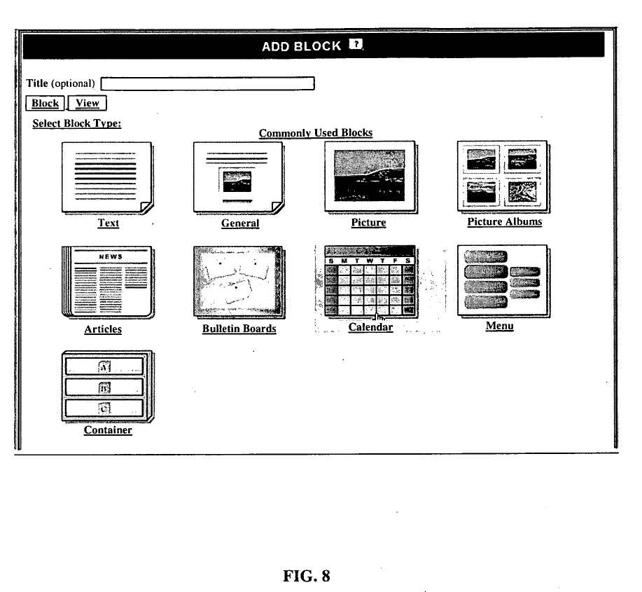

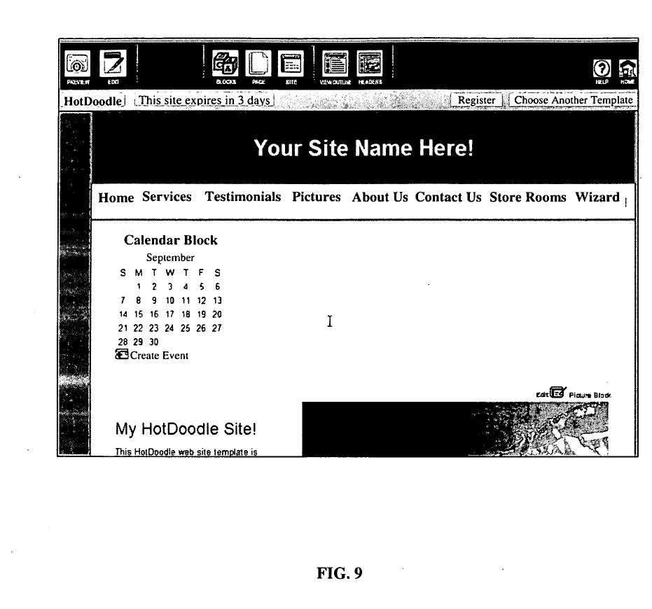

The user 201 may add 302 blocks, for example, text, pictures, and other content stored in a block database 302a in the web server 203. The block database 302a comprises blocks for texts, images, articles, calendars, boards, menus, and containers. The text block in the block database 302a comprises formatted texts and may comprise images. Image galleries store pictures and perform generation of thumbnails of the pictures. The calendar block shows events occurring on certain dates. The articles block provides a list of descriptions of topics. The boards block allows people to reply and post comments on an article. The menus are automatically maintained in the host website and the containers hold a group of blocks. The user 201 may also modify blocks already present in the created user website. For example, the user 201 may modify a header block in the user website to rename the user website. A screenshot of a web page for enabling the user 201 to add blocks to the user website is exemplarily illustrated in FIG. 8. A screenshot of a web page of the user website with the added calendar block is exemplarily illustrated in FIG. 9.

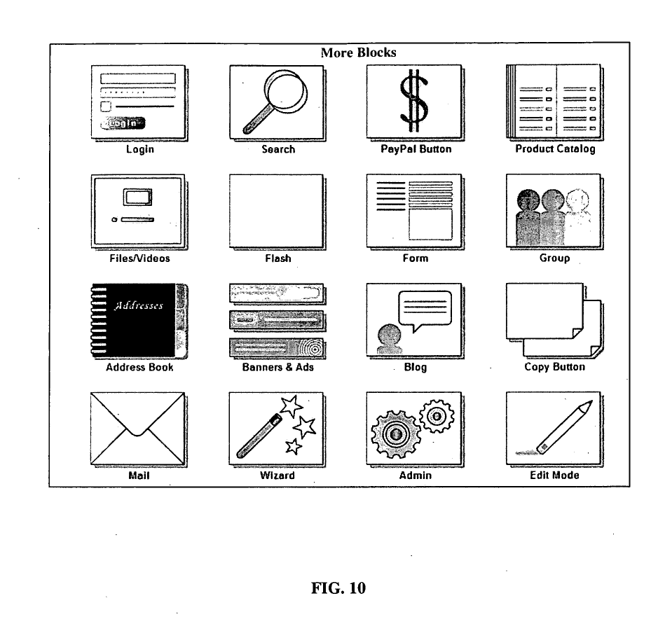

The block database 302a further comprises additional blocks for specialized purposes, for example, address books, admin control panels, banner managers, bulletin boards, clones, contact forms, flash animations, user interface switchers, form makers, groups, hidden image managers, listing managers, login screens, navigation blocks, online payment options, resource managers, search engines, and web logs. A screenshot of an interface enabling the user 201 to add the additional blocks to the user website is exemplarily illustrated in FIG. 10.

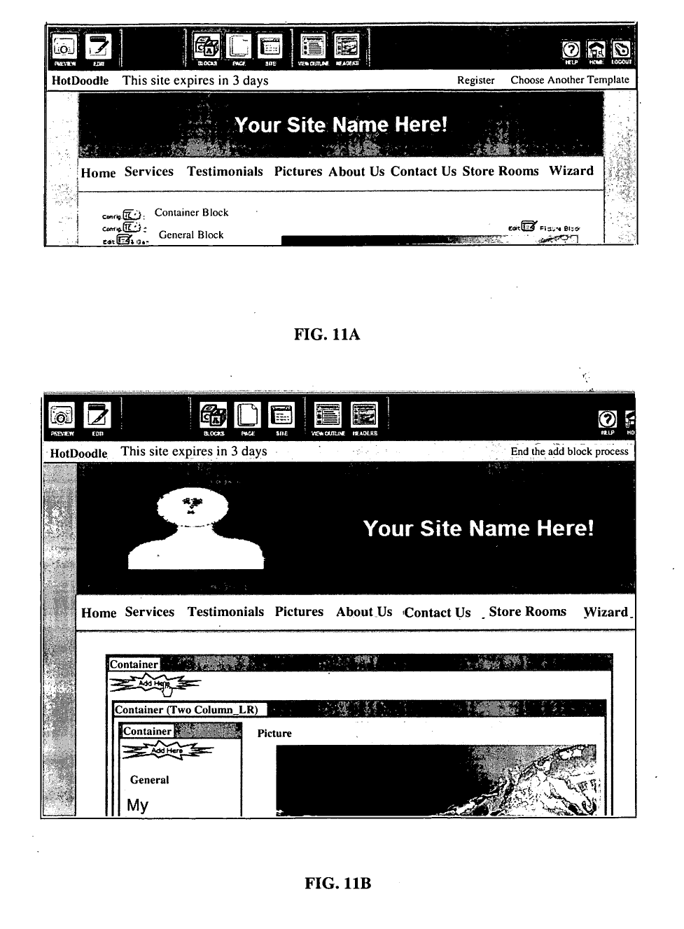

The created user website may notify the user 201 of expiration of the predetermined period of time. Screenshots of web pages of the created user website with the notification of the expiration of the predetermined period of time are exemplarily illustrated in FIGS. 11A-11B. In FIGS. 11A-11B, the notification is a message reading “This site expires in 3 days” in a status bar at the top of the web pages. The user 201 may register 303 with the host website to preserve the results of the customization. The status bar may also provide the user 201a link for enabling the user 201 to register with the host website and be granted unlimited access to the online tools.

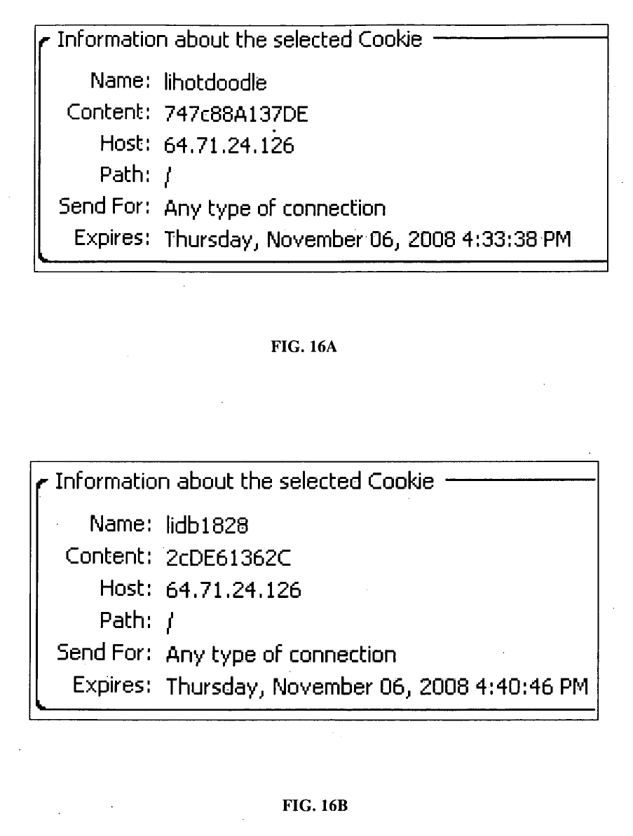

The user 201 may anonymously access the online tools on the host website and create the user website for the predetermined period of time over multiple browser sessions. The temporary user identifier is stored as a web cookie on the client device 202 of the user 201. When the user 201 closes a browser session, the web cookie is not removed from the client device 202. When the user 201 tries to access the online tools on the host website in a second browser session, the host website reads the stored web cookie for the temporary user identifier and grants anonymous access to the user 201. Information on two stored web cookies of the temporary user identifier is exemplarily illustrated in FIGS. 16A-16B.

The stored web cookie exemplarily illustrated in FIG. 16A enables the user 201 to log into a host website whose database is identified as “hotdoodle” as “user #747” if the hash of the user number combined with the host website's secret identification code is “88A137DE”. The hash result is unlikely to be the same for any other combination of a user 201 and a host website. The stored web cookie exemplarily illustrated in FIG. 16B enables the user 201 to log into a host website whose database is identified as “db1828” as “user #2” if the hash of the user number combined with the host website's secret identification code is “DE61362C”.

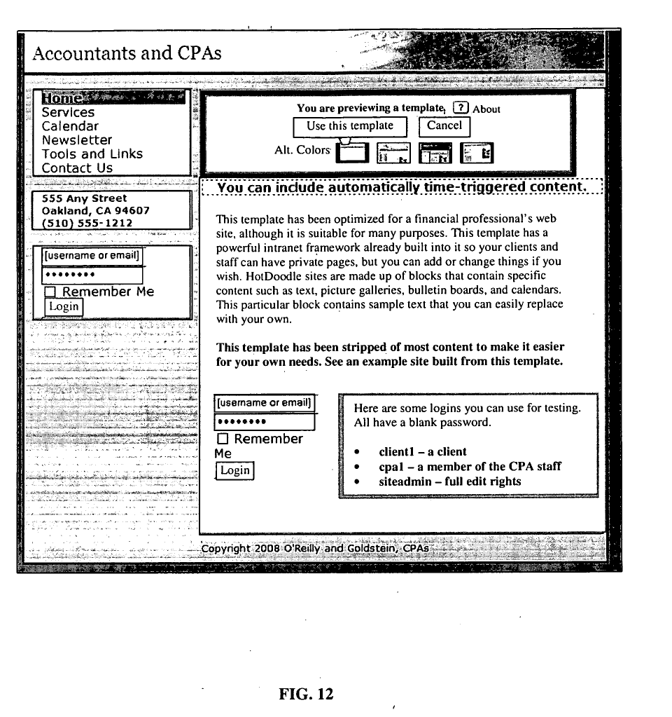

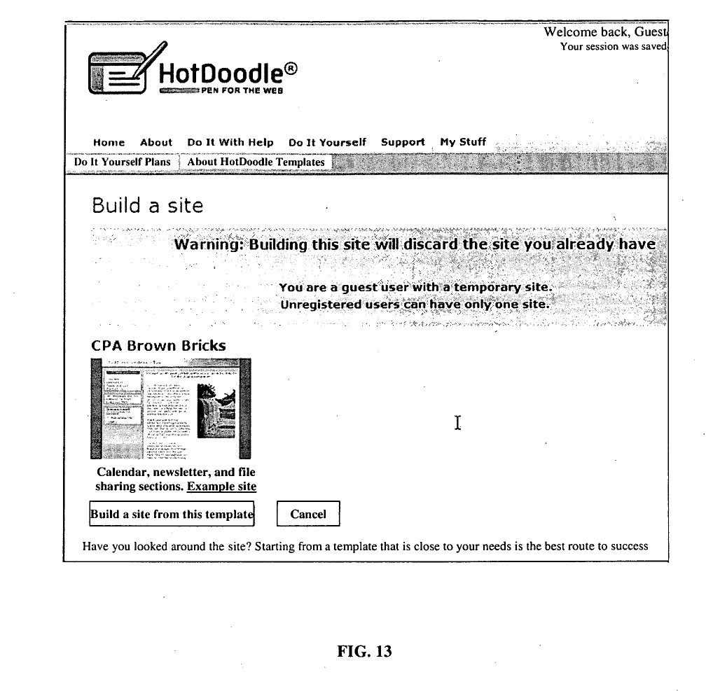

The user 201 accessing the online tools anonymously may be granted limited access to the online tools. In this example, the user 201 is allowed to create only one user website which is valid for a limited period of time. The user 201 may select a new template for the user website. A screenshot of a web page for allowing the user 201 to select a new template for the user website is exemplarily illustrated in FIG. 12. The host website may warn the user 201 that changes made to the user website prior to the changing the template will be lost on changing the template. A screenshot of a web page for warning the user 201 about the loss of the made changes is exemplarily illustrated in FIG. 13. The user 201 may create multiple user websites upon registering with the host website and providing user identification information for example, user name or electronic mail address of the user 201. Unlimited access is granted to the registered user 201.

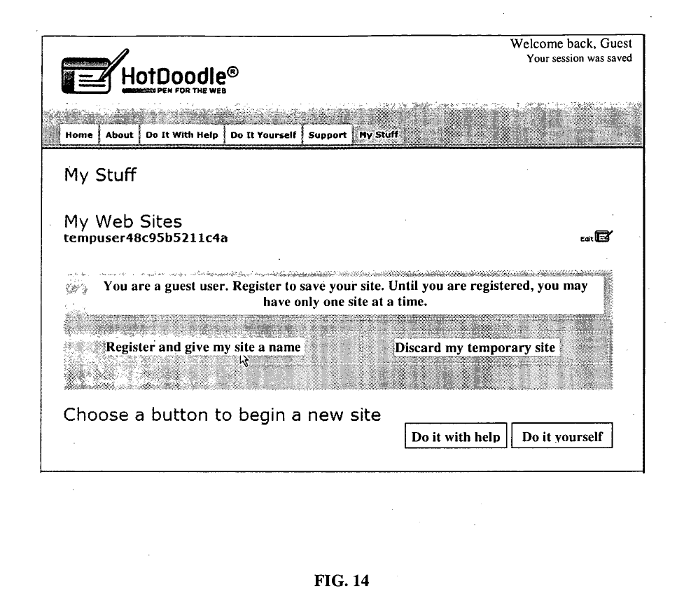

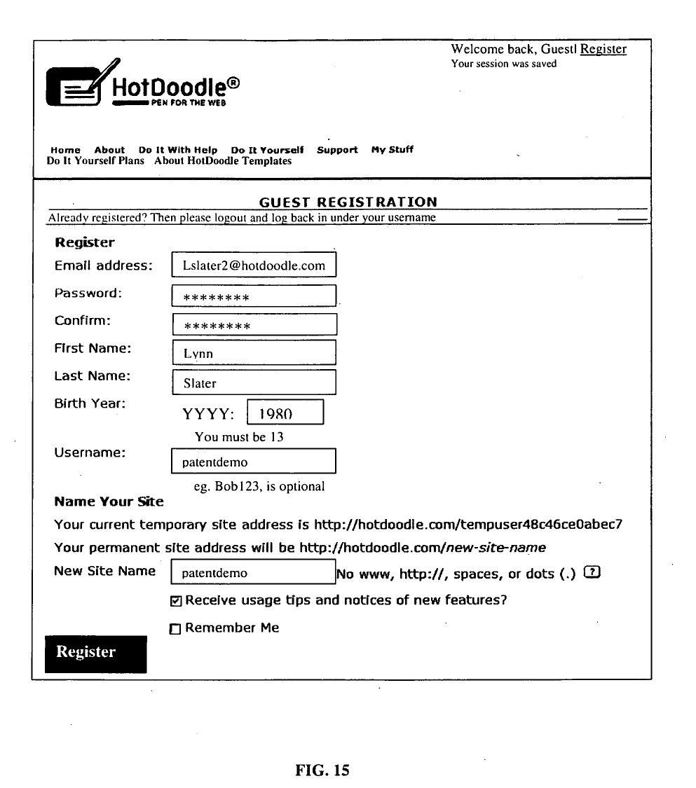

When the predetermined period of time expires, the user website is taken down and the temporary user identifier is rendered invalid. The user 201 may now register to avail of unlimited access. Alternatively, the user 201 may register at any point of time within the predetermined period of time by clicking on a “Register” link. A screenshot of a web page for allowing the user 201 to register with the host website is exemplarily illustrated in FIG. 14. The user 201 provides the user identification information to the host website during the registration. A screenshot of a web page for allowing the user 201 to provide the user identification information to the host website is exemplarily illustrated in FIG. 15. The user identification information is stored in the user database 303a.

The web page exemplarily illustrated in FIG. 15 allows the user 201 to provide a permanent name for the user website. The user 201 may further provide information on the online activities performed prior to providing the user identification information. After registration, the user website is assigned a permanent web address. For example, the user website with the temporary web address “http://64.71.24.126/tempuser48c46ce0abec7” may be assigned a permanent web address “http://64.71.24.126/patentdemo”.

It will be readily apparent that the various methods and algorithms described herein may be implemented in a computer readable medium appropriately programmed for general purpose computers and computing devices. Typically a processor, for e.g., one or more microprocessors will receive instructions from a memory or like device, and execute those instructions, thereby performing one or more processes defined by those instructions. Further, programs that implement such methods and algorithms may be stored and transmitted using a variety of media, for e.g., computer readable media in a number of manners. In one embodiment, hard-wired circuitry or custom hardware may be used in place of, or in combination with, software instructions for implementation of the processes of various embodiments. Thus, embodiments are not limited to any specific combination of hardware and software. A “processor” means any one or more microprocessors, Central Processing Unit (CPU) devices, computing devices, microcontrollers, digital signal processors or like devices. The term “computer-readable medium” refers to any medium that participates in providing data, for example instructions that may be read by a computer, a processor or a like device. Such a medium may take many forms, including but not limited to, non-volatile media, volatile media, and transmission media. Non-volatile media include, for example, optical or magnetic disks and other persistent memory volatile media include Dynamic Random Access Memory (DRAM), which typically constitutes the main memory. Transmission media include coaxial cables, copper wire and fiber optics, including the wires that comprise a system bus coupled to the processor. Transmission media may include or convey acoustic waves, light waves and electromagnetic emissions, such as those generated during Radio Frequency (RF) and Infrared (IR) data communications. Common forms of computer-readable media include, for example, a floppy disk, a flexible disk, hard disk, magnetic tape, any other magnetic medium, a Compact Disc-Read Only Memory (CD-ROM), Digital Versatile Disc (DVD), any other optical medium, punch cards, paper tape, any other physical medium with patterns of holes, a Random Access Memory (RAM), a Programmable Read Only Memory (PROM), an Erasable Programmable Read Only Memory (EPROM), an Electrically Erasable Programmable Read Only Memory (EEPROM), a flash memory, any other memory chip or cartridge, a carrier wave as described hereinafter, or any other medium from which a computer can read. In general, the computer-readable programs may be implemented in any programming language. Some examples of languages that can be used include C, C++, C#, or JAVA. The software programs may be stored on or in one or more mediums as an object code. A computer program product comprising computer executable instructions embodied in a computer-readable medium comprises computer parsable codes for the implementation of the processes of various embodiments.

Where databases are described such as the template database 301a, the block database 302a, and the user database 303a, it will be understood by one of ordinary skill in the art that (i) alternative database structures to those described may be readily employed, and (ii) other memory structures besides databases may be readily employed. Any illustrations or descriptions of any sample databases presented herein are illustrative arrangements for stored representations of information. Any number of other arrangements may be employed besides those suggested by, e.g., tables illustrated in drawings or elsewhere. Similarly, any illustrated entries of the databases represent exemplary information only; one of ordinary skill in the art will understand that the number and content of the entries can be different from those described herein. Further, despite any depiction of the databases as tables, other formats including relational databases, object-based models and/or distributed databases could be used to store and manipulate the data types described herein. Likewise, object methods or behaviors of a database can be used to implement various processes, such as the described herein. In addition, the databases may, in a known manner, be stored locally or remotely from a device that accesses data in such a database.

The present invention can be configured to work in a network environment including a computer that is in communication, via a communications network, with one or more devices. The computer may communicate with the devices directly or indirectly, via a wired or wireless medium such as the Internet, Local Area Network (LAN), Wide Area Network (WAN) or Ethernet, Token Ring, or via any appropriate communications means or combination of communications means. Each of the devices may comprise computers, such as those based on the Intel® processors that are adapted to communicate with the computer. Any number and type of machines may be in communication with the computer.

The foregoing examples have been provided merely for the purpose of explanation and are in no way to be construed as limiting of the present method and system disclosed herein. While the invention has been described with reference to various embodiments, it is understood that the words, which have been used herein, are words of description and illustration, rather than words of limitation. Further, although the invention has been described herein with reference to particular means, materials and embodiments, the invention is not intended to be limited to the particulars disclosed herein; rather, the invention extends to all functionally equivalent structures, methods and uses, such as are within the scope of the appended claims. Those skilled in the art, having the benefit of the teachings of this specification, may effect numerous modifications thereto and changes may be made without departing from the scope and spirit of the invention in its aspects.

We claim:

1. A computer implemented method of enabling a user to anonymously participate in trials over multiple sessions, comprising the steps of:
generating a temporary user identifier for said user, wherein said temporary user identifier is stored locally on a client device of the user;
granting the user anonymous access to a plurality of online tools on a host website for a predetermined period of time using the temporary user identifier; and
enabling the user to participate anonymously in said trials over said multiple sessions using said online tools on said host website for said predetermined period of time, wherein said participation in the trials comprises performing online activities by the user;
whereby the host website enables the user to anonymously participate in the trials over the multiple sessions for the predetermined period of time.

2. The computer implemented method claim 1, further comprising a step of managing content of the trials.

3. The computer implemented method claim 1, wherein the temporary user identifier is stored on the client device as a web cookie.

4. The computer implemented method claim 1, wherein the multiple sessions are multiple browser sessions.

5. The computer implemented method claim 1, further comprising the step of registering with the host website by the user to obtain unlimited access to the online tools, wherein the user registers with the host website by providing user identification information.

6. The computer implemented method claim 1, wherein said online activities comprise providing information and interacting with the host website to create web elements on the host website.

7. The computer implemented method claim 1, further comprising a step of notifying the user of expiration of the predetermined period of time.

8. A computer implemented system for enabling a user to anonymously participate in trials over multiple sessions, comprising:
a web server hosting a host website, comprising:
a user identifier generator for generating a temporary user identifier for said user;
an access control module for granting the user anonymous access to a plurality of online tools on said host website for a predetermined period of time using the temporary user identifier;
an activity module for enabling the user to participate anonymously in said trials over said multiple sessions using said online tools for said predetermined period of time, wherein said participation in the trials comprises performing online activities by the user; and
said client device comprising a storage module for storing the temporary user identifier, and accessing the host website implemented on said web server.

9. The computer implemented system of claim 8, wherein the web server further comprises a content management engine for managing content of the trials.

10. The computer implemented system of claim 8, wherein said storage module stores the temporary user identifier as a web cookie.

11. The computer implemented system of claim 8, wherein the web server further comprises a registration module for registering the user with the host website, wherein the user registers with the host website by providing user identification information to obtain unlimited access to the online tools.

12. The computer implemented system of claim 8, wherein the web server provides the online tools for enabling the user to perform said online activities, wherein the online activities comprise providing information and interacting with the host website to create web elements on the host website.

13. The computer implemented system of claim 8, wherein the web server further comprises a notification engine for notifying the user of expiration of the predetermined period of time.

14. A computer program product comprising computer executable instructions embodied in a computer-readable medium, wherein said computer program product comprises:
a first computer parsable program code for generating a temporary user identifier for a user, wherein said temporary user identifier is stored locally on a client device of said user;
a second computer parsable program code for granting the user anonymous access to a plurality of online tools on a host website for a predetermined period of time using said temporary user identifier;
a third computer parsable program code for enabling the user to participate anonymously in trials over multiple sessions using said online tools for said predetermined period of time, wherein said participation in said trials comprises performing online activities by the user;
a fourth computer parsable program code for notifying the user of expiration of the predetermined period of time; and
a fifth computer parsable program code for registering the user with the host website, wherein the user registers with the host website by providing user identification information to obtain unlimited access to the online tools.
